(19) United States
(12) Patent Application Publication
(10) Pub. No.: US 2005/0023276 A1
(43) Pub. Date: Feb. 3, 2005

(54) Microwavable food packaging with peelable sealing

(75) Inventors: Heidi Hopp, Besenburen (CH); Markus Schultess, Uster (CH)

Correspondence Address: David R. Stevens;Stevens Law Group, P.O. Box 1667, San Jose, CA, 95109, US

(73) Assignee: Wipf AG, Volketswil (CH)

(21) Appl. No.: 10/447,183

(22) Filed: Jul. 30, 2003

(51) Int. Cl. H05B 6/80

(52) U.S. Cl. 219/725; 219/735

(57) ABSTRACT

The invention provides a packaging which has a container part for receiving or containing food, the container part being covered with a sealing cover. The sealing cover comprises at least one vent which serves to release the overpressure generated during the process of microwave cooking. The sealing cover has a peeling strength which lies between 4 and 20 N/15 mm, preferably between 7 and 15 N/15 mm, in particular 8 N/15 mm. According to one embodiment, the sealing cover consists of a PET-PP-composite, with the PP-layer used as the sealing layer, which is sealed to the container. In one embodiment, instead of PET, an oriented polyamide (OPA) is used. In one embodiment, the side of the sealing layer, which faces the lower part of the packaging is covered with an anti-fogging-coating, in order to prevent the condensing of water on the sealing.

### FIELD OF THE INVENTION

The present invention relates to a microwavable food packaging having a peelable sealing.

### BACKGROUND OF THE INVENTION

Since quite some time food packagings are known in which the food is packed in a packaging, e.g. a deep-drawed packaging, which is closed with a sealing cover, i.e. with a cover which is sealed onto the packaging. Furthermore it is known that the cover can have the property that it is peelable, i.e. that it can be peeled from the deep-drawed packaging in order to enable the user to take out or access the food. Such a sealing is e.g. described in DE 44 10 235 C2.

For quite some time packagings with sealed covers have also been used for microwavable food, whereas in such a case so far, however, there has been the problem that in the microwave device there is generated an overpressure which somehow has to be balanced with or to be released to the outside, in other words the pressure has to be released to the surrounding area outside of the packaging. For some time, however, also this problem is solved by incorporating a vent into the sealed cover which releases the overpressure generated inside the packaging to the outside. Such a microwavable food packaging is e.g. described in EP 0 971 849 B1.

In case of the microwavable food packagings having a sealed cover, however, there is the problem that the cover is not peelable, at least not after the cooking process. Since during the process of cooking or heating relatively high pressures (up to approx. 1 bar overpressure) may be generated and since temperature may rise up to 120° C., the sealed cover has to be comparatively resistant and stable in order to avoid that the packaging bursts during cooking. In addition to this high resistivity the cover should still keep its good peeling properties while being exposed to the rather extreme conditions during the cooking process.

The food packagings known so far either need to be opened before the cooking starts in order to prevent them from bursting, or they do not have good peeling properties after the cooking process.

An object of the present invention therefore consists in providing a microwavable food packaging which has a peelable cover, which still is able to bear the relatively extreme conditions which arise during the cooking process in unopened form, and which still shows good peeling properties after the cooking properties to make it easy for the user to access the food.

### SUMMARY OF THE INVENTION

According to a first embodiment the present invention comprises a packaging which has a container part for receiving or containing food, the container part being covered with a sealed cover, whereas the sealed cover comprises at least one vent which serves to release the overpressure generated during the process of microwave cooking whereas the cover sealing or sealed cover has a peeling strength which lies between 4 and 20 N/15 mm, preferably between 7 and 15 N/15 mm, in particular 8 N/15 mm.

According to a preferred embodiment the sealing consists of a PET-PP-composite with the PP-layer used as the sealing layer which is sealed to the container. The thickness of the PET-layer lies between 10 and 16μ, preferably it has a thickness of 12μ. The thickness of the sealing layer preferably is in the range between 70 and 110μ, preferably it is 90μ.

According to a further embodiment instead of PET an oriented polyamide (OPA) with a thickness between 10 and 20μ, preferably having a thickness of 15μ, can also be used.

According to a preferred embodiment the side of the sealing layer which faces the lower part of the packaging is covered with an anti-fogging-coating in order to prevent the condensing of water on the sealing. This keeps the cover transparent even during or after the cooking process.

According to a preferred embodiment the peeling strength or peeling force of the sealable cover lies in the range between 9 and 12 N/15 mm before the anti-foging-coating is applied, preferably at 10 N/15 mm. After the coating has been applied the peeling strength then is reduced to approx. 8 N/15 mm.

According to a further embodiment the peeling strength of the sealing cover not having applied an anti-foging-coating thereto lies between 7 and 10 N/15 mm, preferably at 8 N/15 mm.

According to a preferred embodiment the vents which are used in the cover designed such that the overall area or total area of the holes of the vent are sufficient in order to release the overpressure generated during the cooking process. For that purpose it is decisive that the area of the holes of the one or more vents altogether which are incorporated in the packaging is suitably designed. Preferably the total area is at least 12 mm², preferably it is more than 21 mm². According to a particularly preferred embodiment the overall area of all holes of the vent used in the packaging is between 23.2 and 23.3 mm².

The present invention is now explained in detail by making reference to the accompanying drawings.

### BRIEF DESCRIPTION OF THE DRAWINGS

FIG. 1 schematically illustrates a vent packaging having a sealable and peelable cover according to a first embodiment of the present invention.

FIGS. 2A-2H schematically illustrate examples of vents which can be used in connection with a packaging according to an embodiment of the present invention.

### DETAILED DESCRIPTION

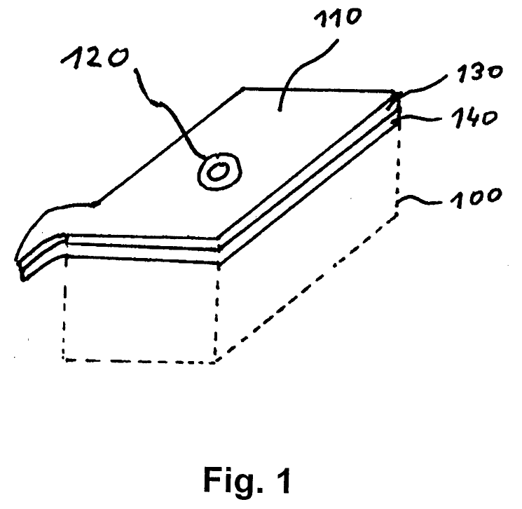

FIG. 1 schematically illustrates a microwavable packaging according to a first embodiment of the present invention. The lower part of the packaging (the container part) shown in dashed lines is sealed and covered with the sealable and peelable cover 110 into which the vent 120 is incorporated, according to a preferred embodiment by sealing it into the cover 110. As schematically indicated in FIG. 1 the cover 110 thereby consists of two laminated layers 130 and 140, whereas the upper layer 130 is thinner than the lower sealing layer 140.

According to the first embodiment the sealing layer is a peelable layer formed on a polypropylene (PP)-basis having a thickness of 90μ. The upper layer 130 is a PET-layer having a thickness of 12μ which is laminated onto the lower layer 140.

According to an embodiment of the present invention the composite cover sealed onto the packaging is designed such that the peeling strength is sufficient to resist the temperatures and pressures generated during the microwave cooking process, Furthermore it is designed such that after having finished the cooking process the sealing cover still has a good peeling property. In case of the first embodiment of the present invention to achieve this object a particular material is used as a sealing cover which comprises a foil or film as sealing foil or film 140 having a peeling strength of 8 N/15 mm². It is a foil or film (or sheet) formed of a polypropylene-basis which is particularly heat resistant and which has a peeling strength suitable for the pressures generated during the microwave cooking when being sealed onto the container. A foil or film or cover suitable as a sealing layer according to a first embodiment of the present invention is for example the foil or film sold under the label PROPEEL-100 by the company KWH Plast Ltd., Finland. This sealing layer is then laminated together with a PET-layer layer to form a composite layer. The composite layer is then sealed onto the container. The thickness of the sealing layer thereby is 90μ, thickness of the upper layer which in this embodiment is formed by a PET-layer, is 12μ. With the sealing layer formed by the PROPEEL foil or film it is possible to achieve a peeling strength which can resist the rather extreme conditions under the cooking process and which still shows good peeling properties so that a user after the cooking can easily peel the cover from the container.

For the skilled person it is clear that certain modifications of the thicknesses of the individual layers are possible as long as the resulting peeling forces and the peeling properties are still in a range which is suitable for the purported application.

For example, in case of a further embodiment the upper layer of the cover sealing may be formed by a OPA having a thickness which lies in the range between 10 and 20μ, and which preferably is 15μ.

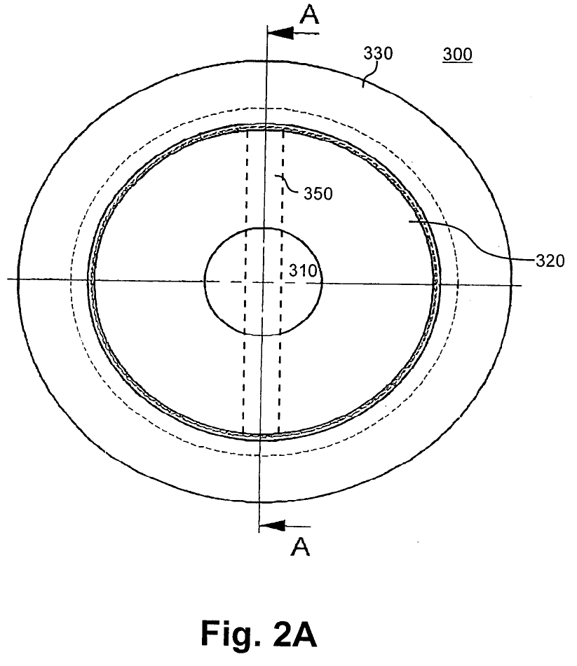

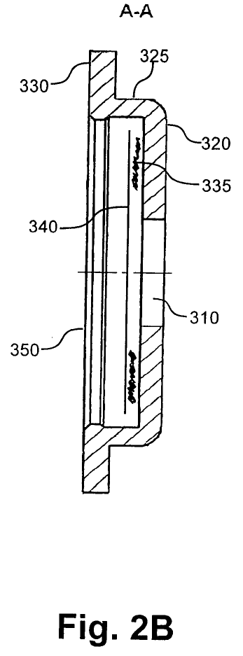

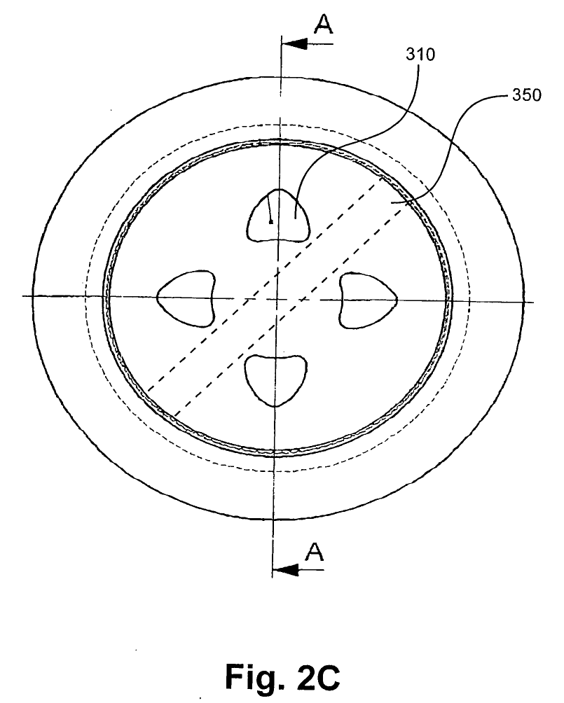

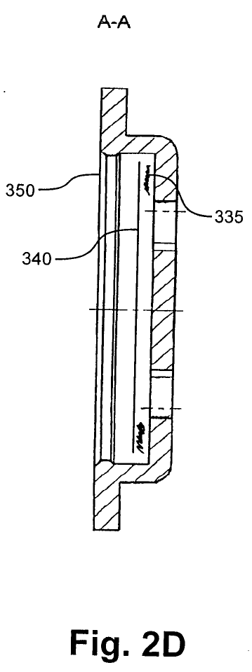

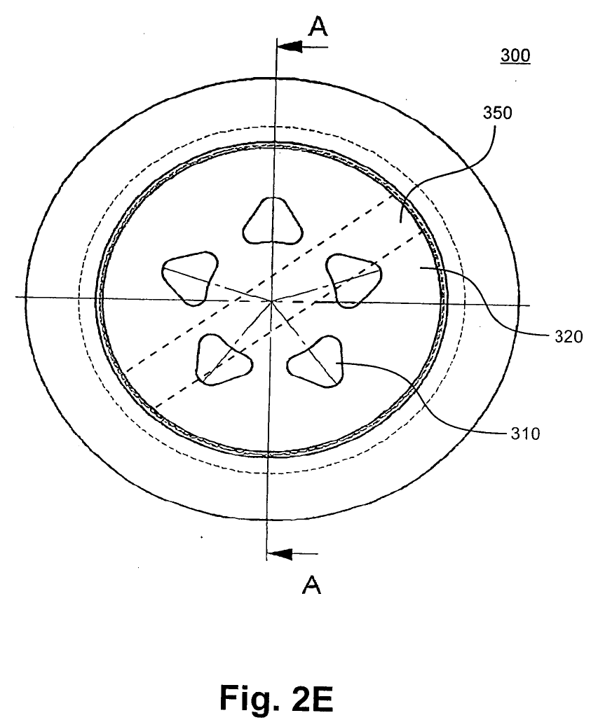

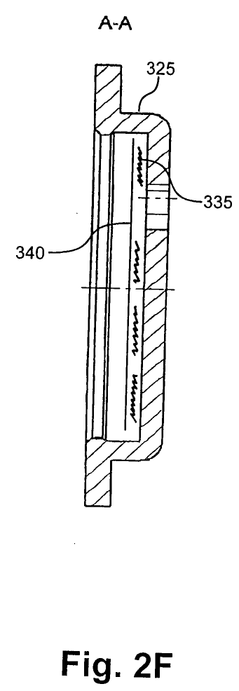

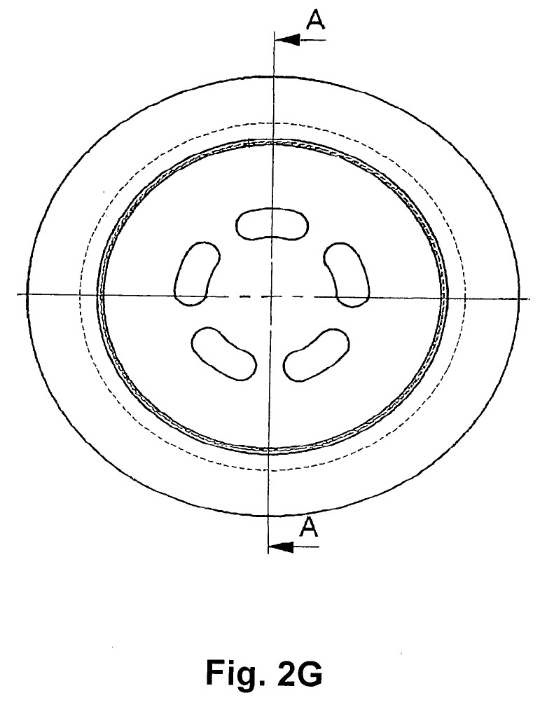

As already mentioned there is a vent 120 incorporated into the sealing cover, the vent serving to release the overpressure generated during the cooking. This vent now is described by making reference to FIG. 2A. Further descriptions of the basic function of this vent can e.g. found DE 198 43 430 A1, as well as in EP 0 069 264 B1.

FIG. 2A thereby shows a first example of a vent in a top view. The corpus 300 of the vent in its center has a hole 310, from the hole 310 there extends a bearing surface for bearing a membrane lying thereupon and extending up to a flange 330 which enables the mounting of the vent on e.g. a packaging.

The bar 350 prevents the membrane from falling out of the vent corpus. The bar is mounted over the area 320 and fixed by a clamping force between the opposite sides of the side walls of the vent.

FIG. 2B shows a sectional view through the vent shown in FIG. 2A. In the sectional view of 2B besides the bearing area 320 and the flange 330 also the side wall 325 of the vent corpus can be recognized well. Furthermore in FIG. 2B there is shown the membrane 340 which is lying on the bearing area 320. Between the area 320 and the membrane 240 there is inserted a sealing oil which makes sure that the hole 310 is covered in a an air-tight manner which prevents air from being released through the hole 310.

The bar 350 is mounted between the side walls 325 of the vent corpus and makes sure that the membrane cannot fall out from the vent corpus.

As can be clearly seen in FIG. 2A the vent comprises a comparatively big hole in the middle of the bearing area 320. The bar 350 is dimensioned such it does not completely cover the hole, however, it may also be designed such that the hole is completely covered, as long as the bar is not exerting any pressure onto the membrane as shown in FIG. 2B. If the bar exerts a direct pressure onto the membrane, then, however, it is preferred if the bar does not completely cover the hole area in order not to impede a release of air through the hole and thereby a release of overpressure generated during a cooking process. The vent allows the release of an overpressure generated during cooking by lifting the membrane and allowing the release of an overpressure through the hole.

FIG. 2C shows a further example of a vent according to another embodiment. Altogether four holes 310 are provided which are respectively in the same radial distance from the vent center. The four holes thereby are arranged symmetrically, i.e. the distance between two neighboring holes always is the same. In case of FIG. 2C it can be recognized that the bar 350 is located just between the holes and thereby ensures that it does not prevent the release of an overpressure through any of the holes. The holes thereby are in the form of equilateral triangles whereas the corners of the triangles are slightly rounded. With this shape of the holes there can be achieved a particularly efficient release of the overpressure property with respect to re-closing of the vent.

A sectional view of the vent of FIG. 2C is shown in FIG. 2D. Also here the bar 350, the membrane 340, and the sealing oil 335 can be recognized.

Finally, FIGS. 2E and 2F show a further embodiment of a vent for a microwavable food packaging according to an embodiment of the invention. Because of the odd number of holes it is thereby made sure that at least one of the holes always is covered by the bar as can be seen from FIG. 2F.

A further embodiment of a vent which may be used in connection with the food packaging is shown in a top view in FIG. 2G. The in total five holes thereby are in the shape of bended long holes. The (not shown) sectional view thereby corresponds—depending on the cutting plane—the one shown in FIG. 2D or in FIG. 2F.

The shape of the holes of the vent shown in FIG. 2A to FIG. 2G may also take the shape of circles, while such embodiments here are not shown in the Figs. In principle it is also possible to have more than five holes. According to a preferred embodiment the vent, however, has at least three, preferably five holes. According to a further embodiment as shown in FIG. 2A it is also possible to use a vent having only a single hole.

Important for the application as a pressure vent during a microwave cooking process is the overall area of the holes. In case of the vent of FIG. 2A this area is 23.24 mm², in case of the vent of FIG. 2C it is 23.25 mm², in case of the vent of FIG. 2E it is 23.20 mm², and in case of the vent of FIG. 2E it is 23.28 mm². It is clear to the expert that certain modifications of the overall area of the holes are possible, however, the total area of the holes preferably is at least 12 mm², in particular more than 21 mm² are preferred, and a particularly preferred embodiment has a total area of the holes of 23 mm².

According to a further embodiment the peelable sealing cover has an anti-fogging-property, i.e. the surface property of the cover is changed such that in the inner side no condensed drops are formed which might prevent the user from viewing the food (in case of a transparent cover, of course). For that purpose the side of the cover which faces the food is coated with an anti-fogging solution in order to prevent the condensing of liquid, in particular water. A coating which is particularly suited for that purpose is the one which is sold under the label 15-029331-4-DFC sold by the company Siegwerk, Germany. The application of the anti-fogging-coating to achieve the anti-fog-properties changes the peeling strength of the cover. Therefore in this embodiment as a sealing layer a cover a foil or film is used which has a slightly higher peeling strength, preferably 2 N/15 mm more than the one to which no anti-fogging-coating is applied. Therefore the peeling strength for the sealing cover in this embodiment lies at 10 N/15 mm. After application of the coating the peeling strength decreases to approx. 8 N/15 mm. A particularly suited foil or film suitable as a sealing layer 140 in the cover of this embodiment is sold under the label GS Retopeel by the company GS Technologies, Flintshire, Great Britain.

The sealing layer then is laminated together with a PET-upper layer to a composite foil or film or composite sheet to be used as a cover and to be sealed onto the container. The thickness of the sealing layer 140 in this embodiment also is 90μ, also the thickness of the upper PET-layer 130 remains unchanged at 12 p like in the previous embodiment. However, also in this case it should be recognized that modifications are possible for the skilled person as long as the resisting properties against pressure and temperature still are sufficient, and as long as the peeling strength still is in a suitable range.

Also in this embodiment vents according to FIG. 2A-2G may be applied.

With the application described in the embodiments there is provided a microwavable food packaging which not only is suitable for microwave cooking, but which also is particularly easy to use for the user because the sealing cover is peelable and still is able to resist the temperatures and pressures generated during microwave cooking, while the sealing cover is still able to regulate these temperatures and in particular these pressures.

1. Microwavable food packaging, comprising:
a container part for holding food;
a sealing cover sealed onto the container part;
at least one vent incorporated into the sealing cover for releasing the overpressure generated during microwave cooking whereas the sealing cover comprises:
a peeling strength between 4 and 90 NS/15 um, preferably between 7 and 14 N/15 mm, in particular 8 N/15 mm, whereas the sealing cover comprises.
a PET-PP composite layer with the PP-layer as sealing layer.

2. Microwavable food packaging, comprising:
a container part for holding food;
a sealing cover sealed onto the container part;
at least one vent incorporated into the sealing cover for releasing the overpressure generated during microwave cooking whereas the sealing cover comprises:
a peeling strength between 4 and 90 N/15 mm, preferably between 7 and 14 N/15 mm, in particular 8 N/15 mm, whereas the sealing cover comprises:
a OPA-PP-composite layer with the PP-layer as sealing layer.

3. Food packaging according to claim 1, whereas the sealing cover comprises:
said sealing layer having a thickness between 70 and 110μ; and
a second layer formed on the sealing layer, the second layer being formed of PET and having a thickness between 10 and 16μ.

4. Food packaging according to claim 2, whereas the sealing cover comprises:
a said sealing layer having a thickness between 70 and 110μ, preferably between 80 and 100μ, in particular 90μ; and
a second layer formed on the sealing layer, whereas the second layer is formed of OPA and has a thickness between 10 and 20μ.

5. (canceled).

6. Food packaging according to claim 1, whereas the side of the sealing layer which faces the lower packaging part is coated with an anti-fogging-coating.

7. Food packaging according to claim 6, whereas the peeling strength of the sealing layer before the anti-fog-coating lies between 9 and 12 N/15 mm.

8. (canceled).

9. Food packaging according to claim 1, whereas the total area of the holes of the one or more vents incorporated into the cover is at least 17 mm².

10. (canceled).
